(19) United States
(12) Patent Application Publication
(10) Pub. No.: US 2009/0064847 A1
(43) Pub. Date: Mar. 12, 2009

(54) Musical Notation System Patterned upon the Standard Piano Keyboard and Referenced with the Grand Staff

(76) Inventor: Jia Hao, Beijing (CN)

Correspondence Address: HAO Jia, House 1023, Villa Yosemite, Shunyi District, Beijing, 101302, CN

(21) Appl. No.: 12/212,709

(22) Filed: Sep. 18, 2008

Related U.S. Application Data
(63) Continuation-in-part of application No. 11/277,502, filed on Mar. 26, 2006, now Pat. No. 7,439,438.

(51) Int. Cl. G09B 15/02

(52) U.S. Cl. 84/483.2

(57) ABSTRACT

The present invention is a continuation-in-part of the inventor's prior invention (USPTO application Ser. No. 11/277,502 filed on 26 Mar. 2006), the added feature being a “Grand Staff reference marking” added to a row of the “staff of gray and white pitch stripes” of the prior invention, the said marking comprising one or more set of Grand Staff of five lines, the Grand Staff clef or clefs, with each Grand Staff line pointing or connected to a corresponding correct “white pitch stripe”. Such “Grand Staff reference marking” feature enables the precise identification of the pitch stripes relative to their corresponding keys on the piano keyboard, and in terms of pitch names commonly used by students of music theories. The pitch names of all other pitch stripes can be easily derived from its physical location in relation to those pitch stripes connected to or pointed to by the lines of the “Grand Staff reference marking”.

### BACKGROUND OF THE INVENTION

1. Technical Field

Musical staff and notation system.

2. Background

The present invention is a continuation-in-part of the inventor's prior invention (USPTO application Ser. No. 11/277,502 filed on 26 Mar. 2006).

Every object of the present invention is the same as the prior invention, i.e.,
To replace or bypass the Grand Staff, which is a high threshold of the world of music;
To make it much easier, than using the Grand Staff, to obtain scores on different Keys.

### DISCLOSURE OF INVENTION

Every aspect of the present invention is the same as the prior invention, but with the following added feature:

A “Grand Staff reference marking” is added to the left, or both left and right, of a row of the “staff of gray and white pitch stripes” of the prior invention, the said marking comprising one or more set of Grand Staff of five lines, the Grand Staff clef or clefs, with each Grand Staff line pointing or connected to a corresponding correct “white pitch stripe”.

Because the Grand Staff lines, with the help of the clef or clefs, represent certain keys on the standard piano keyboard, such “Grand Staff reference marking” feature enables the precise identification of the pitch stripes relative to their corresponding keys on the piano keyboard, and in terms of pitch names commonly used by students of music theories, such as e1, g1, b1, d2, f2 for the five lines with a “G clef”, or g, b, d1, f1, a1 for the five lines with a “F clef”. And because the pitch stripes in the prior invention corresponds one-to-one to the keys on the piano keyboard, the pitch names of all other pitch stripes can be easily derived from its physical location in relation to those pitch stripes connected to or pointed to by the lines of the “Grand Staff reference marking”.

Same as the prior invention, when all the pitch stripes are of the same vertical width, musical scores of the same music but in different keys can be easily obtained by shifting all the notes and markings of the original music score collectively up or down the blank musical staff.

### BRIEF DESCRIPTION OF THE DRAWINGS

The drawings are for illustration purposes and shall not limit the claims of the invention.

FIG. 1: Pitch stripes marked by Grand Staff reference marking with a G clef.

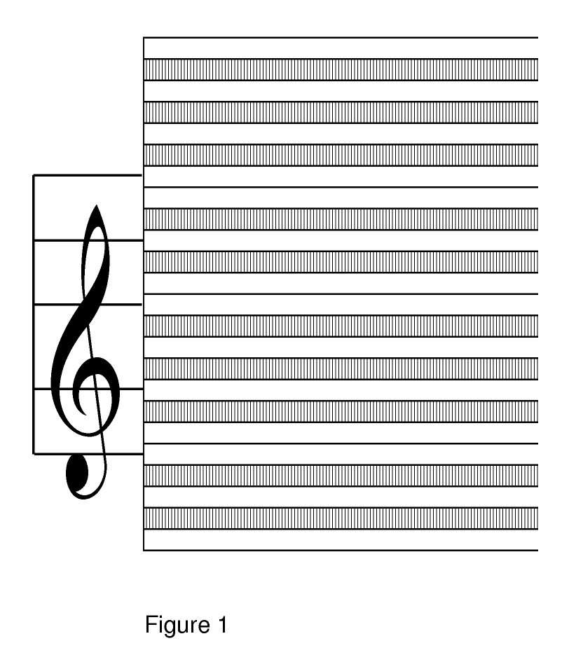

FIG. 2: Pitch stripes marked by Grand Staff reference marking with a F clef

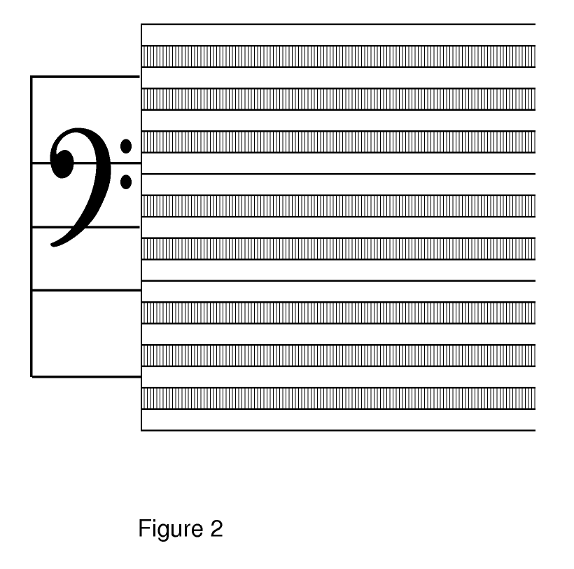

FIG. 3: Pitch stripes marked by Grand Staff reference marking comprising 2 sets of Grand Staff of 5 lines, one with a G clef and the other with a F clef, bracketed together, which is usually the format used for piano music scores.

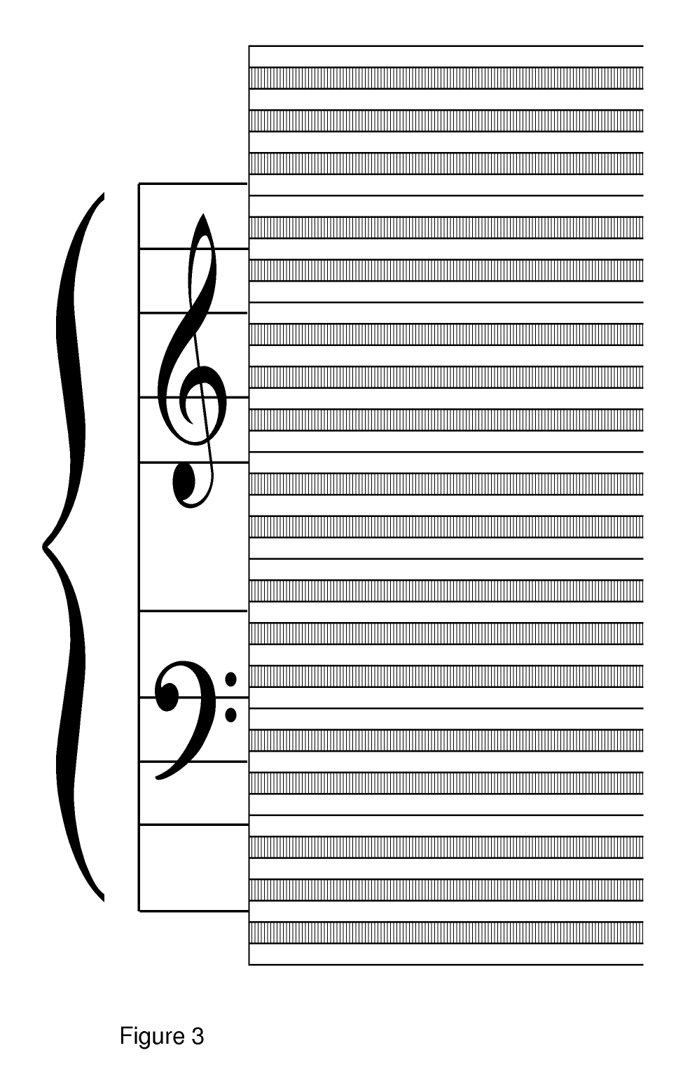

### BEST MODE FOR CARRYING OUT INVENTION

Books or other printed materials can be produced with the said blank musical staff of pitch stripes with the added feature to help compose, copy, or publish musical scores (by writing or typing on the blank musical staff).

Computer programs or software can be produced with the said blank musical staff of pitch stripes with the added feature to help compose, enter, copy, transmit, import, export, publish, or print musical scores. Such computer programs or software can also be made with the function to assist producing music scores on shifted Keys using the above said method.

A special kind of tool-book can be produced in which the contents of the music (notes and other markings) and the blank staff of pitch stripes can be printed on separate sheets with one of them (e.g. the blank staff of pitch stripes) being printed on transparent sheets. The tool-book can be designed and made in such a way that the sheets with the contents of the music and the (transparent) sheets with the blank staff of pitch stripes can move vertically against each other, so that music scores on shifted Keys can be obtained or produced using the said above said method.

1. The invention claimed is an improved musical notation system for recording and representing musical scores, comprising:
a staff, or stave, of horizontally arranged pitch stripes of two colors, stacked up together;
pitch stripes of one color represent the black keys of the standard piano keyboard;
pitch stripes of the other color represent the white keys of the standard piano keyboard;
pitch stripes lying in relatively lower positions correspond to the keys lying relatively more towards the left-hand side of the piano keyboard;
pitch stripes lying in relatively higher positions correspond to the keys lying relatively more towards the right-hand side of the piano keyboard;
the vertical pattern of arrangement from low to high of the pitch stripes of two colors is identical to the horizontal arrangement from left to right of the black and white keys of the standard piano keyboard;
the single staff comprises the number of pitch stripes (some may be additionally added short “ledger stripes”) to span all the notes of a line of music;
music notes and symbols that are commonly used with the Grand Staff, such as time signatures, barlines, whole notes or semi-breves, half notes or minims, quarter notes or crotchets, eighth notes or quavers, sixteenth notes or semi-quavers, thirty-second notes or demi-semi-quavers, sixty-fourth notes or hemi-demi-semi-quavers, hundred twenty-eighth notes or quasi-hemi-semi-quavers and two hundred fifty-sixth notes, rests, dots, ties, beams, tuplets, signs for tempo, dynamics, mood, articulation (phrasing, slurs, staccato, etc.), reiterations and repeats, expressions, ornaments and embellishments, etc., all as commonly found and described in English dictionaries or encyclopedias published in the United States of America or the United Kingdom;
a “Grand Staff reference marking” is added to the left, or both left and right, of a row of the said staff, the said marking comprising one or more set of Grand Staff of five lines, the Grand Staff clef or clefs, with each Grand Staff line pointing or connected to a corresponding correct white pitch stripe;
music scores are produced by marking the aforesaid music notes on the aforesaid staff, positioning the note-heads of the said music notes upon the correct pitch stripes indicating the correct keys on the piano keyboard to be played.

2. The musical notation system for recording and representing musical scores of claim 1, wherein,
all the pitch stripes are of the same vertical width; and
producing a musical score in different scales is performed by shifting all the notes and markings of an original music score collectively up or down the blank musical staff and amending the key signature accordingly.
